(19) United States
(12) Patent Application Publication
(10) Pub. No.: US 2026/0251865 A1
(43) Pub. Date: Aug. 27, 2026

(54) Optical Circuit Chips

(71) Applicant: NTT, Inc., Tokyo (JP)

(72) Inventors: Yusuke Nasu, Musashino-shi, Tokyo (JP); Takashi Yamada, Musashino-shi, Tokyo (JP); Kiyofumi Kikuchi, Musashino-shi, Tokyo (JP); Yuriko Kawamura, Musashino-shi, Tokyo (JP)

(21) Appl. No.: 18/863,971

(22) PCT Filed: May 12, 2022
(86) PCT No.: PCT/JP2022/020083

§ 371 Date: Nov. 7, 2024

(51) Int. Cl. G02B 6/42

(52) U.S. Cl. CPC G02B 6/4228

(57) ABSTRACT

An optical circuit chip including an optical circuit connected to a fiber array is provided. At this time, an optical chip includes a substrate including a high refractive index layer, a low refractive index layer having a lower refractive index than the high refractive index layer, a lower cladding layer, and an upper cladding layer including the high refractive index layer and the low refractive index layer and having a lower refractive index than the low refractive index layer; a high refractive index core connected to an optical circuit formed in the high refractive index layer, low refractive index cores formed in the low refractive index layer and connected to the high refractive index core; and at least a pair of alignment waveguides formed in the low refractive index layer and having one end portion connected to an end surface of the substrate facing the fiber array.

### TECHNICAL FIELD

The present disclosure relates to an optical circuit chip included in an optical module.

### BACKGROUND ART

In optical communication systems, optical components are included in integrated optical circuits in order to meet demands for further miniaturization, a reduction in cost, and a large capacity. Integrated optical circuits can be configured on the basis of various materials. However, in recent years, Si photonics in which silicon (Si) is used as a core material has attracted attention. Silicon has a larger refractive index than a known low refractive index material. Si photonics has stronger optical confinement than an optical circuit of a low refractive index material and can reduce an allowable value of a bending radius of an optical waveguide. Various circuit elements such as an optical coupler, a multiplexer, a filter, a modulator, and an optical receiver included in an optical circuit can be realized with Si photonics, and further an optical circuit in which these components are integrated in one chip can be downsized.

In order to actually use optical circuits in which Si photonics is utilized, terminals capable of inputting and outputting light and electricity are provided in integrated Si photonic chips. Si photonic chips capable of inputting and outputting light and the like are connected to optical fibers of a fiber arrays to configure optical modules.

It is preferable to connect Si photonic chips to optical fibers so that an optical loss due to the connection is sufficiently low. Alignment at the time of connection of the optical fibers is performed, for example, through active alignment in which light is incident on the optical fibers, and optimum alignment positions are searched for while monitoring the intensity of light transmitted or reflected by optical circuits in Si photonic chips. The active alignment is described in, for example, Non Patent Literature 1.

### CITATION LIST

### Non Patent Literature

Non Patent Literature 1: Suruga Seiki Co., Ltd., hikari faiba choshin, choshin shisutemu (In Japanese) (Optical Fiber Adjustment, Adjustment System), [retrieved on Apr. 21, 2022], Internet <https://jpn.surugaseiki.com/dcms_media/other/504_Alignment-System_Web.pdf>

### SUMMARY OF INVENTION

Here, a problem of alignment of an optical module will be described. FIG. 1 is a top view illustrating connection between a known Si photonic chip C and an optical fiber 23. An optical waveguide of the Si photonic chip C includes a plurality of input/output units 11. An optical fiber 23 including the core 21 and a cladding layer is fixed to a fiber array F. The optical fiber 23 is fixed by passing the fiber array F through the optical fiber 23 and applying an adhesive 22 around the fiber array F. A spot size converter (SSC) may be provided at a connection portion between the optical fiber 23 and the input/output unit 11 to expand a mode field diameter (MFD). The fiber array F has various assembly forms such as a lens-attached fiber array.

In assembly of the optical module, it is necessary to accurately align the core 21 of the optical fiber 23 and the input/output unit 11 and efficiently input light of a laser light source (not illustrated) or the like to the optical waveguide. Necessary alignment accuracy is required to be at least about 0.1 μm to 1.0 μm. Such highly accurate alignment is difficult in alignment in which image processing is used and is therefore performed through active alignment that is performed while causing light to be actually incident on the input/output unit 11 from the optical fiber 23 and monitoring a coupling loss. In the example of the configuration illustrated in FIG. 1, incident light is observed by a photodetector or the like provided in the Si photonic chip C in alignment between the Si photonic chip C and the fiber array F. However, in observation of light performed using a photodetector, the photodetector is required to be driven in an optical circuit while causing light to be incident, and thus there is a disadvantage that this operation is complicated.

An optical circuit using Si photonics has a very large refractive index and strong optical confinement. As a result, a mode field diameter of an optical waveguide used in the optical circuit is as small as several hundreds of nm, and is greatly different from a mode field diameter of the optical fiber 21 of about several μm to 10 μm. Although the SSC is provided in the input/output unit 11 to expand the mode field diameter so that the mode field diameter becomes close to the mold field diameter of the optical fiber 21, it is difficult to sufficiently reduce the connection loss between the Si photonic chip C and the optical fiber 23 even by such a technique.

An object of the present disclosure is to solve such a problem, and relates to an optical circuit chip in which a photonic chip and an optical fiber can be easily connected with high accuracy and has a small coupling loss.

In order to achieve the foregoing object, an optical circuit chip according to an aspect of the present disclosure is an optical circuit chip that includes an optical circuit connected to a fiber array and includes: a substrate including a first layer, a second layer having a lower refractive index than the first layer, and a third layer including the first layer and the second layer and having a lower refractive index than the second layer; a first optical waveguide connected to the optical circuit formed in the first layer; a second optical waveguide formed in the second layer and connected to the first optical waveguide; and at least a pair of alignment waveguides formed in the second layer and having one end portion connected to an end surface of the substrate facing the fiber array.

According to the foregoing aspect, it is possible to provide an optical module in which the photonic chip and the optical fiber can be easily connected with high accuracy and has a small coupling loss.

### BRIEF DESCRIPTION OF DRAWINGS

FIG. 1 is a top view illustrating connection between a known Si photonic chip and an optical fiber.

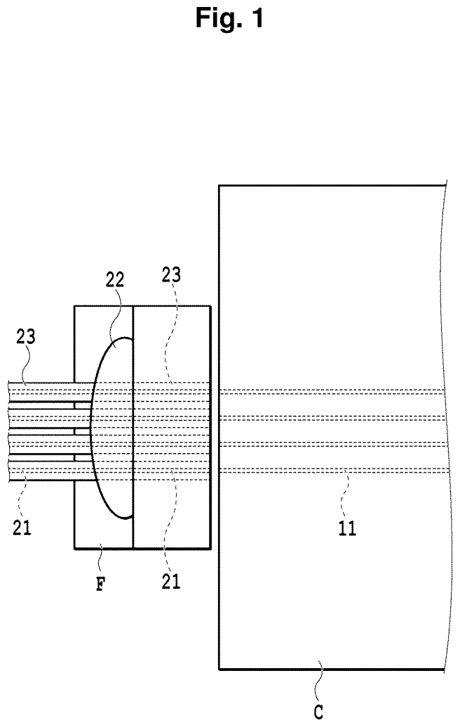

FIG. 2(a) is a top view and FIG. 2(b) is a cross-sectional view illustrating a substrate according to a first embodiment.

FIG. 3(a) is a top view and FIG. 3(b) is a cross-sectional view illustrating an optical module according to the first embodiment.

FIG. 4(a) is a top view and FIG. 4(b) is a cross-sectional view illustrating an effect according to the first embodiment.

FIG. 5(a) is a top view and FIG. 5(b) is a cross-sectional view illustrating an optical module according to a second embodiment.

FIG. 6(a) is a top view illustrating a configuration of an optical module according to a third embodiment, and FIG. 6(b) to 6(d) are top views illustrating alignment performed in the optical module.

FIGS. 7(a) and 7(b) are views illustrating an alignment process of an optical module according to a fourth embodiment.

### DESCRIPTION OF EMBODIMENTS

Hereinafter, first to fourth embodiments of the present invention will be described with reference to the drawings. However, the drawings are used to describe configurations, arrangement, advantageous effects, and technical ideas of units according to the embodiments, and do not necessarily indicate aspect ratios and dimensional shapes of the configurations illustrated in the drawings accurately. The embodiments do not limit specific shapes of the configurations illustrated in the drawings. An optical module according to an embodiment includes a substrate and an optical circuit mounted on the substrate. In the drawings, in the following description, a direction in which the optical circuit is mounted is referred to as “upper” when the substrate is a reference.

### First Embodiment

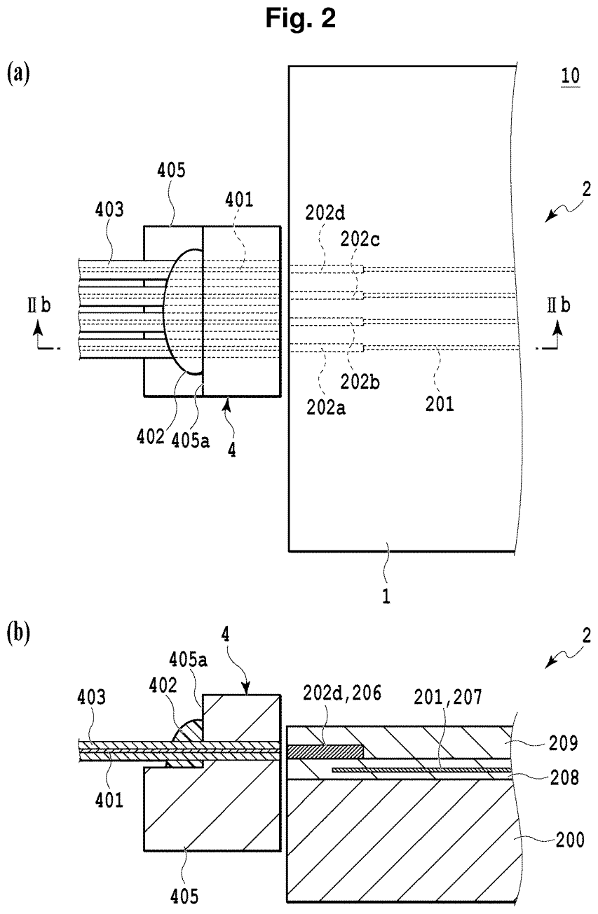

FIGS. 2(a) and 2(b) are diagrams illustrating a configuration of a substrate of an optical module 10 according to a first embodiment. The optical module 10 includes an optical circuit chip 2 and a fiber array 4. FIG. 2(a) is a schematic top view illustrating a state in which the optical circuit chip 2 and the fiber array 4 are aligned. FIG. 2(b) is a schematic cross-sectional view taken along the arrows IIb and IIb of FIG. 2(a). The optical module 10 according to the first embodiment of the present disclosure includes a high refractive index layer 207 which is a first layer, and a low refractive index layer 206 which is a second layer having a lower refractive index lower than the high refractive index layer 207. Further, the optical module 10 includes a high refractive index layer 207 and a low refractive index layer 206, and includes a lower cladding layer 208 and an upper cladding layer 209 which are third layers having a refractive index lower than that of the low refractive index layer 206. The high refractive index layer 207, the low refractive index layer 206, the lower cladding layer 208, and the upper cladding layer 209 are included in a substrate 1 of the optical circuit chip 2. The substrate 1 is a planar optical circuit substrate.

The fiber array 4 includes a substrate 405, a stepped portion 405a formed in the substrate 405, and four optical fibers 403 penetrating through the stepped portion 405a. The four optical fibers 403 have cores 401, and are fixed to the substrate 405 in parallel by an adhesive 402 applied between the cores 401 and the stepped portion 405a.

According to the foregoing configuration, light incident from the optical fiber 403 passes through the low refractive index cores 202a to 202d of the optical circuit chip 2 and propagates to the high refractive index cores 201. The high refractive index core 201 functions as an input/output unit connected to an optical circuit (not illustrated).

The optical circuit chip 2 includes a lower cladding layer 208 formed on a Si substrate 200 serving as a circuit support substrate, and the high refractive index layer 207 is formed on the lower cladding layer 208. The high refractive index layer 207 is processed to the high refractive index core 201 by known photolithography and etching. The low refractive index layer 206 is formed on the high refractive index core 201. The low refractive index cores 202a, 202b, 202c, and 202d which are second optical waveguides are formed in the low refractive index layer 206 by known photolithography and etching. The low refractive index cores 202a to 202d are formed by processing the low refractive index layer 206 by known photolithography and etching.

The foregoing process may be performed, for example, by depositing the lower cladding layer 208 on the Si substrate 200, and further forming the high refractive index layer 207 and performing etching to form the high refractive index core 201. Further, the lower cladding layer 208 and the upper cladding layer 209 may be deposited from the high refractive index core 201, a part of the upper cladding layer 209 may be etched and removed in accordance with the low refractive index cores 202a to 202d, and the low refractive index layer 206 may be deposited after the removing. The upper cladding layer 209 is further deposited on the low refractive index cores 202a to 202d. In the optical module 10 configured as described above, the high refractive index core 201, the low refractive index core 202a, and the like are disposed with a part of the upper cladding layer 209 interposed therebetween. Light output from an optical circuit (not illustrated) propagates from the high refractive index core 201 to the low refractive index core 202a or the like through the upper cladding layer 209.

In the first embodiment, the low refractive index cores 202a to 202d are SSC, and optical coupling is implemented while changing a spot size of light so that light output from the optical fiber side of the optical module 10 can be optically coupled to the optical waveguide formed by the high refractive index core 201, the lower cladding layer 208, and the upper cladding layer 209 at a low loss. Such a configuration is effective in a reduction in a connection loss of the optical module 10 in the first embodiment.

The high refractive index layer 207 is a layer that has Si as a basic optical waveguide structure and has a refractive index substantially equal to that of Si. The low refractive index layer 206 may be an insulating layer that has a lower refractive index than Si. For example, SiN, SiOₓ, or SiNO is used. The lower cladding layer 208 and the upper cladding layer 209 may be, for example, SiO₂ known as a material of the cladding layer. According to such a layer structure, an optical waveguide structure including a double core layer is implemented. A spacing between the high refractive index layer 207 and the low refractive index layer 206 is preferably an inter-layer distance capable of adiabatically coupling light in consideration of a coupling loss. Further, it is preferable to set the optical waveguide structure including the high refractive index core 201 and the low refractive index core 202d as a structure that has a small coupling loss.

The optical module according to the first embodiment is designed such that the optical waveguide structure is a double structure of the high refractive index core 201 and the low refractive index core 202d, a side of the low refractive index layer 206 in FIG. 2 facing the optical fiber array 4 matches a mode field diameter of the optical fiber 403, and a side of the low refractive index layer 206 facing an optical circuit (not illustrated) has a mode field diameter by which an optical waveguide used in the optical circuit can be optically coupled with low loss. Further, in the first embodiment, by setting the low refractive index layer 206 as the SSC, the spot size gradually changes in a traveling direction of light. In this way, it is possible to avoid an optical connection loss occurring due to a difference between the mold diameter of the optical fiber 403 and the mode field diameter of the optical waveguide used in the optical circuit of the optical circuit chip 2. Further, in the first embodiment, since the low refractive index cores 202a to 202d are SSC, the mode field diameter can be adjusted with higher accuracy to further reduce the connection loss with the fiber array 4. Further, in the optical circuit chip 2 in which the mode field diameter is expanded, a connection tolerance between the low refractive index cores 202a to 202d and the optical fiber 403 is improved, and the alignment accuracy required at the time of connection of the optical fiber is significantly alleviated.

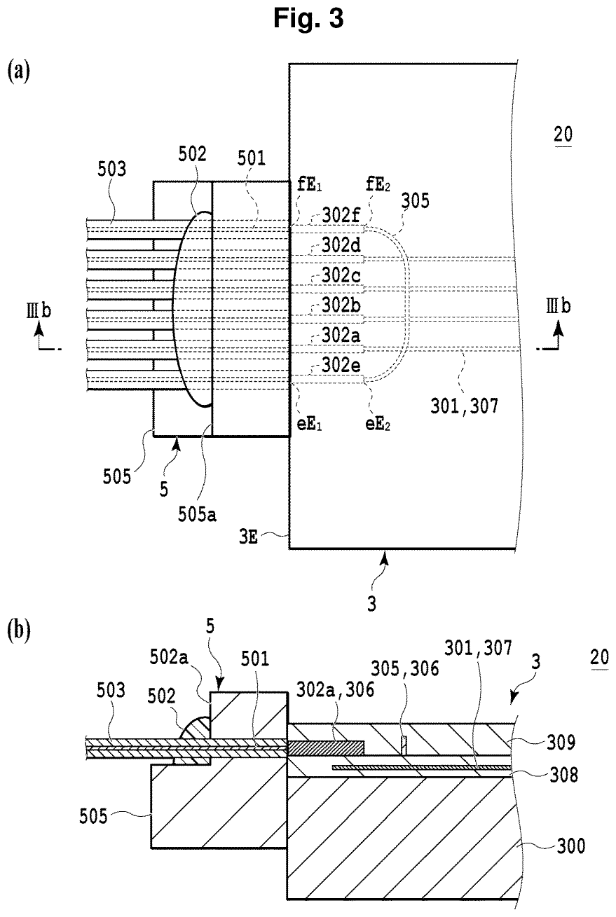

Next, an optical module 20 according to the first embodiment in which the optical module 10 further includes an alignment mechanism will be described. FIGS. 3(a) and 3(b) are views illustrating the optical module 20 according to the first embodiment. FIG. 3(a) is a top view of the optical module 20, and FIG. 3(b) is a cross-sectional view taken along the arrows IIIb and IIIb of FIG. 3(a). The optical module according to the first embodiment includes an optical circuit chip 3 and a fiber array 5. The optical circuit chip 3 includes a Si substrate 300, a high refractive index core 301 formed by a high refractive index layer 307, and low refractive index cores 302a to 302d formed by a low refractive index layer 306. Further, the optical circuit chip 3 includes a lower cladding layer 308 including a pair of alignment cores 302e and 302f which are alignment waveguides, the high refractive index core 301, and the low refractive index cores 302a to 302d in the low refractive index layer 306, and an upper cladding layer 309. In the alignment core 302e, one end portion eE1 is connected to an end surface 3E of the optical circuit chip 3 facing the fiber array 5, and the other end portion eE2 is connected to one end portion fE2 of the alignment core 302f. The other end portion fE1 of the alignment core 302f is connected to the end surface 3E. The end portion eE2 and the end portion fE2 are connected by an optical waveguide 305. The alignment cores 302e and 302f and the optical waveguide 305 are all formed in the low refractive index layer 306 and are connected in the low refractive index layer 306.

The fiber array 5 includes a stepped portion 505a in the substrate 505, and includes six optical fibers 503 corresponding to the low refractive index cores 302a to 302d and the alignment cores 302e and 302f of the optical circuit chip. Each optical fiber 503 includes a core 501, penetrates through the stepped portion 505a, and is fixed to the substrate 505 by an adhesive 502.

The alignment of the optical module 20 according to the first embodiment is performed by causing light to be incident from a light source (not illustrated) such as a laser from the optical fiber 503 connected to the alignment core 302e. The light incident on the optical fiber 503 propagates into the alignment core 302e, and further passes through the optical waveguide 305 and is incident on the alignment core 302f. The light exits from the alignment core 302f through the optical fiber 503 and is monitored by, for example, a d-type optical power meter. The alignment is performed by adjusting a relative position of the optical fiber 503 to the optical circuit chip 3 so that intensity of the monitored light is the highest. A pitch of the optical fiber 503 corresponds to a pitch of the low refractive index cores 302a to 302d, and the low refractive index cores 302a to 302d and the optical fiber 503 are also connected through core adjustment using the alignment cores 302e and 302f so that the optical axes thereof match each other. Hereinafter, this adjustment is referred to as “alignment”.

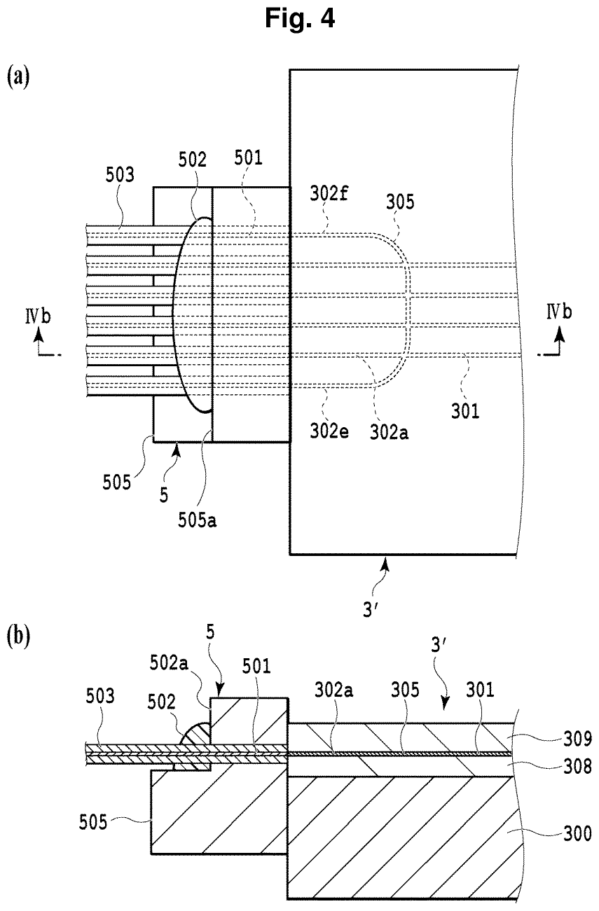

Next, an effect of forming such alignment cores 302e and 302f and the optical waveguide 305 in the low refractive index layer 306 will be described. FIGS. 4(a) and 4(b) are diagrams illustrating an optical module when an alignment core is formed in a high refractive index layer. FIG. 4(a) is a top view and FIG. 4(b) is a cross-sectional view of the optical module taken along the arrows IVb and IVb illustrated in FIG. 4(a). In an optical circuit chip 3′ illustrated in FIG. 4, the alignment cores 302e and 302f and the optical waveguide 305 are all formed in the high refractive index layer along with the high refractive index core 301. In this way, the high refractive index core 301 and the optical waveguide 305 intersect each other, and a large optical loss occurs in the high refractive index core 301.

On the other hand, in the optical module 20 according to the first embodiment, a core has a double structure of the high refractive index core 301 and the low refractive index cores 302a to 302d. Then, in the optical module 20, the low refractive index cores 302a to 302d, the alignment cores 302e and 302f, and the optical waveguide 305 are formed in the low refractive index layer 306 to avoid the intersection of the optical waveguide 305 and the high refractive index core 301. With such a configuration, according to the first embodiment, it is possible to prevent an optical loss of the high refractive index core 301.

In the optical module 20, incidence and monitoring of light are possible only by an optical power meter and a light source of the alignment device. Therefore, it is possible to simplify the alignment of the optical circuit chip 3 and the fiber array 5. Further, in the optical module 20 according to the first embodiment, a photodetector may not be provided in the optical circuit, and downsizing and simplifying of the optical circuit of the optical circuit chip 3 are effective.

### Second Embodiment

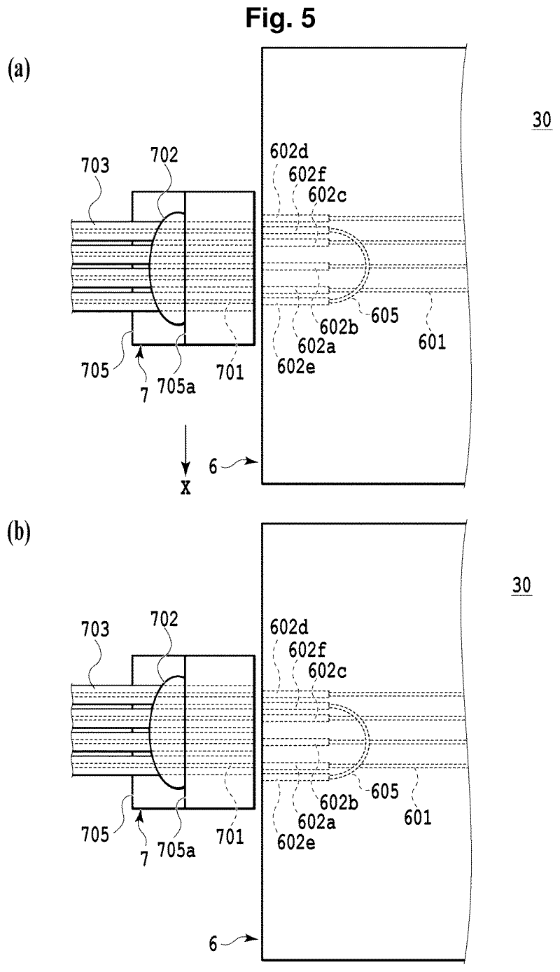

Next, a second embodiment will be described. The second embodiment is different from the first embodiment in that an optical fiber for alignment is not separately formed in a fiber array, and alignment is performed using an optical fiber 703 through which light is input to and output from an optical circuit chip 6. FIGS. 5(a) and 5(b) are diagrams illustrating an optical module 30 according to the second embodiment. FIGS. 5(a) and 5(b) are both top views illustrating the optical circuit chip 6 and the fiber array 7 during alignment. The optical circuit chip 6 includes a high refractive index core 601 and low refractive index cores 602a, 602b, 602c, and 602d. Also in the second embodiment, the low refractive index cores 602a to 602d have an SSC structure. Further, the optical circuit chip 6 includes alignment cores 602e and 602f. The alignment cores 602e and 602f are connected by the optical waveguide 601.

The fiber array 7 includes a substrate 705 having a stepped portion 705a and optical fibers 703 disposed in parallel through the stepped portion 705a. The optical fiber 703 includes a core 701 and is fixed to the substrate 705 by an adhesive 702. In the second embodiment, a spacing between the pair of alignment cores 602e and 602f is equal to a spacing between any two of the plurality of optical fibers 703.

The optical circuit chip 6 and the fiber array 7 configured as described above are aligned as follows. As illustrated in FIG. 5(a), the optical circuit chip 6 and the fiber array 7 are first aligned using the alignment cores 602e and 602f and the optical fiber 703. After the alignment is completed, the fiber array 7 is moved in the −X direction illustrated in FIG. 5(a), and the low refractive index cores 602a to 602d and the optical fiber 703 are connected as illustrated in FIG. 5(b).

With Si photonics, the optical circuit chip and the fiber array are manufactured with high accuracy. An error in relative positions between the low refractive index cores 602a to 602d and the alignment cores 602e and 602f, and the optical fiber 703 is as small as about 1 nm. Thus, in the second embodiment, the fiber array 7 is moved by a known length after alignment, and the low refractive index cores 602a to 602d and the optical fiber 703 can be connected so that the optical axes match each other. The known length may be, for example, a design value of a spacing between the alignment core 602e and the low refractive index core 602a of the optical circuit chip 6.

In the foregoing second embodiment, since it is not necessary to provide an optical fiber for alignment in the fiber array 7, a cost of the fiber array 7 can be further reduced than in the first embodiment.

### Third Embodiment

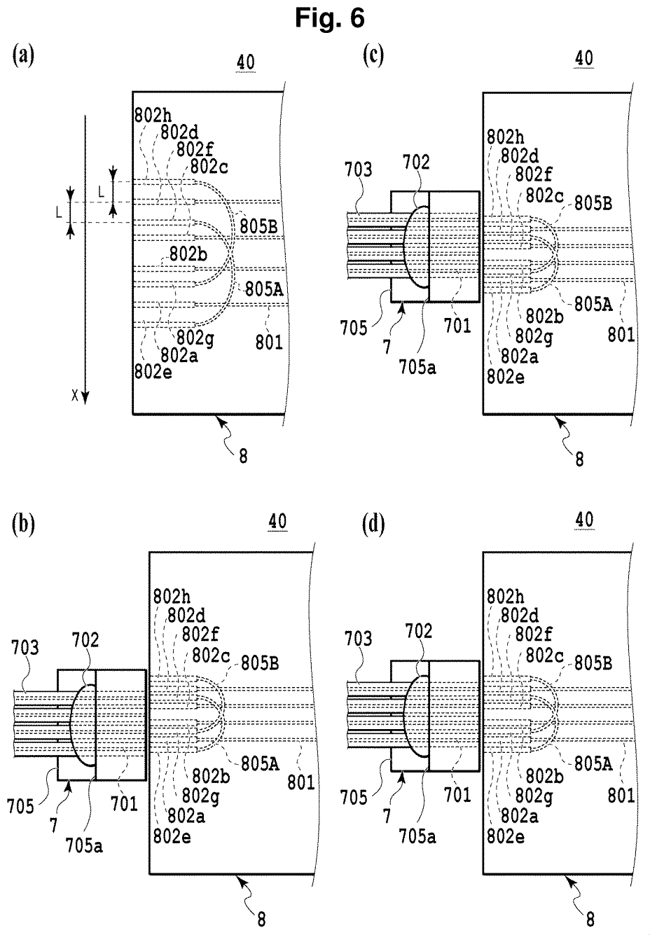

Next, an optical module 40 according to a third embodiment will be described. FIGS. 6(a), 6(b), 6(c), and 6(d) are top views illustrating the optical module 40 according to the third embodiment. FIG. 6(a) illustrates a configuration of the optical module, and FIGS. 6(b) to 6(d) illustrate alignment performed in the optical module 40. In the third embodiment, alignment can be performed with higher accuracy than in the second embodiment without providing an optical fiber for alignment on the fiber array 7 side as in the second embodiment.

As illustrated in FIGS. 6(b) to 6(d), the optical module 40 includes an optical circuit chip 8 and the fiber array 7. As illustrated in FIG. 6(a) and the like, the optical circuit chip 8 includes four high refractive index cores 801 and four low refractive index cores 802a to 802d. Further, the optical circuit chip 8 includes two pairs of alignment cores 802e and 802f and alignment cores 802g and 802h. The alignment cores 802e and 802f are connected by an optical waveguide 805A, and the alignment cores 802g and 802h are connected by an optical waveguide 805B. In the third embodiment, the low refractive index cores 802a to 802d are also included in an SCC.

In the following description, in the third embodiment, a circuit that includes the alignment cores 802e and 802f and the optical waveguide 805A is also referred to as an alignment circuit A, and a circuit including the alignment cores 802g and 802h and the optical waveguide 805B is also referred to as an alignment circuit B. In the optical circuit chip 8 illustrated in FIG. 6(a), the alignment circuit B and a light input/output circuit including the low refractive index cores 802a to 802d are disposed to be shifted by a distance L in the −X direction, and the alignment circuit B is disposed to be shifted by the distance L in the X direction. In the third embodiment, as will be described in detail below, the optical circuit chip 8 and the fiber array 7 are aligned using the alignment circuit A, and the optical circuit chip 8 and the fiber array 7 are subsequently aligned using the alignment circuit B. Then, the optical circuit chip 8 and the fiber array 7 are connected at the center of optimal positions determined through the two alignments.

Both the optical waveguides 805A and 805B are formed in the low refractive index layer. Therefore, the optical waveguides 805A and 805B may intersect each other. The optical waveguides 805A and 805B do not affect the connection loss unless the optical waveguides 805A and 805B intersect the high-refractive index core 801. The optical loss due to the intersection of the optical waveguides 805A and 805B does not affect the alignment accuracy of the optical circuit chip 8 and the fiber array 7.

Since the fiber array 7 performs alignment using the existing optical fibers 703, the spacing between any two of the optical fibers 703 matches the spacing between the alignment cores of the optical circuit chip 8.

As illustrated in FIG. 6(b), the optical circuit chip 8 and the fiber array 7 are aligned using the alignment circuit A. The alignment is performed by monitoring light incident and exiting through the alignment core 802e, the optical waveguide 805A, and the alignment core 802f. Next, the optical circuit chip 8 and the fiber array 7 are aligned using the alignment circuit B as illustrated in FIG. 6(c). In switching of the alignment circuits A and B, the fiber array 7 is moved in the −X direction in FIG. 6(a) using a stage (not illustrated).

The alignment by the alignment circuit B is performed by monitoring the light incident and exiting through the alignment core 802g, the optical waveguide 805B, and the alignment core 802h. At this time, as apparent from FIGS. 6(b) and 6(c), an optimum position of the fiber array 7 determined in the alignment circuit A using the optical circuit chip 8 as a reference is different from an optimum position of the fiber array 7 determined in the alignment circuit B. In the third embodiment, the fiber array 7 is connected to the optical circuit chip 8 at the center of the optimum alignment position determined through the alignment performed twice. The optimum position determined through the alignment using the alignment circuits A and B is based on a relative position between the optical circuit chip 8 and the fiber array 7. When the optimum position is expressed by, for example, only the X axis, the center of the optimum position may be, for example, a point at the center of two optimum positions represented by coordinates of the stage.

According to the foregoing third embodiment, the connection position between the optical circuit chip 8 and the fiber array 7 can be determined using the relative positional relation between the optical circuit chip 8 and the fiber array 7 as a reference. Therefore, in the third embodiment, even when the absolute accuracy of a movement amount of the stage that moves the fiber array 7 is not sufficiently high, it is possible to appropriately align the optical circuit chip 8 and the fiber array 7 and to implement connection with a small optical loss. In the third embodiment, as in the second embodiment, the accuracy of alignment can be improved as compared with the case where the fiber array is moved from the position determined by the alignment using the absolute movement distance of the stage as a reference. Many known stages have higher accuracy of relative positions than absolute positions, and thus the third embodiment is effective in implementation of the optical module 40 with a small coupling loss.

### Fourth Embodiment

Next, an optical module 10 according to a fourth embodiment will be described. The fourth embodiment is different from the first embodiment in that the alignment cores 112e and 112f include one SSC and a reflection circuit. As the reflection circuit, for example, a loop rearview mirror or the like is suitably used. When the reflection circuit is used for alignment, it is necessary to form the reflection circuit sufficiently away from the circuit (present circuit) in order to avoid intersection with the present circuit that inputs and outputs light. However, since the reflection circuit is a relatively large circuit, the optical circuit chip is increased in size by being separated from the present circuit. In the alignment circuit and the present circuit, as the distance increases, a final movement amount of the fiber array increases and the accuracy of alignment decreases. In order to solve such a problem, according to the fourth embodiment, an alignment circuit including a reflection circuit is formed in a low refractive index layer, and the circuit is formed in a high refractive index layer.

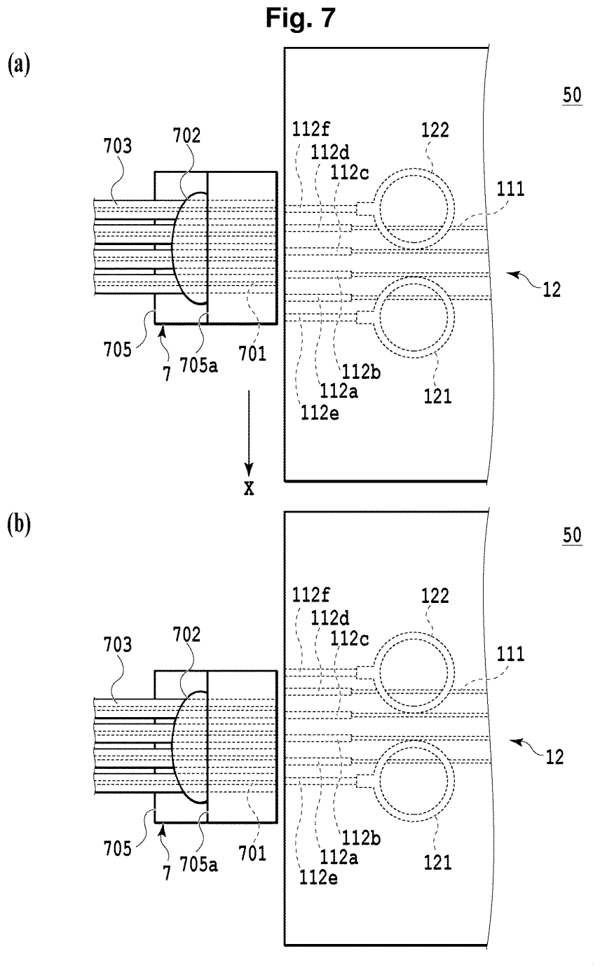

FIGS. 7(a) and 7(b) are top views illustrating an optical module 50 according to the fourth embodiment, and each illustrate an alignment process. The optical module 50 includes an optical circuit chip 12 and the fiber array 7. The optical circuit chip 12 includes a high refractive index core 111 formed in a high refractive index layer, low refractive index cores 112a to 112d formed with a low refractive index, the alignment cores 112e and 112f, and reflection circuits 121 and 122. In the fourth embodiment, the alignment core 112e, the reflection circuit 121, the alignment core 112f, and the reflection circuit 122 are included in an alignment circuit.

As illustrated in FIGS. 7(a) and 7(b), alignment between the optical circuit chip 12 and the fiber array 7 is first performed by causing light to be incident on the alignment core 112f from the optical fiber 703 and monitoring the intensity of reflected light. When a position at which the intensity of the light is largest is determined, the fiber array 7 is moved by a known distance in the X direction by a stage or the like (not illustrated). The position after the movement is a position at which the optical axes of the alignment core 112e and the optical fiber 703, that is, the core 201, is considered to substantially match. Here, in the fourth embodiment, light is incident on the alignment core 112e from the optical fiber 703, and the reflected light is monitored to perform alignment.

According to the fourth embodiment, the alignment circuit and the present circuit are separated from each other in a thickness direction together with a planar direction of the optical circuit chip 12, and it is possible to prevent an increase in the area of the optical circuit chip 12. As illustrated in FIGS. 7(a) and 7(b), by providing at least two alignment circuits including an alignment core and the reflection circuit and performing alignment, it is possible to ascertain an inclination and a position of the fiber array 7, and reduce the connection loss with the optical circuit chip 12.

### REFERENCE SIGNS LIST

1 Substrate
2, 3, 6, 8, 12 Optical circuit chip
3E End surface
4, 5, 7 Fiber array
10, 20, 30, 40, 50 Optical module
111, 201, 301, 601, 801 High refractive index core
112a to 112d, 202a to 202d, 302a to 302d, 602a to 602d, 802a to 802d Low refractive index core
112e, 112f, 202e, 202f, 302e, 302f, 602e, 602f, 802e, 802f, 802g, 802h Alignment core
121, 122 Reflection circuit
200, 300 Si substrate
206, 306 Low refractive index layer
207, 307 High refractive index layer
208, 308 Lower cladding layer
209, 309 Upper cladding layer
305, 805A, 805B Optical waveguide
401, 501, 701 Core
403, 503, 703 Optical fiber
402, 502 Adhesive
405, 505, 705 Substrate
405a, 505a, 705a Stepped portion

1. An optical circuit chip that includes an optical circuit connected to a fiber array, the optical circuit chip comprising:
a substrate including a first layer, a second layer having a lower refractive index than the first layer, and a third layer including the first layer and the second layer and having a lower refractive index than the second layer;
a first optical waveguide connected to the optical circuit formed in the first layer;
a second optical waveguide formed in the second layer and connected to the first optical waveguide; and
at least a pair of alignment waveguides formed in the second layer and having one end portion connected to an end surface of the substrate facing the fiber array.

2. The optical circuit chip according to claim 1, wherein the other end portions of the pair of alignment waveguides are connected to each other in the second layer.

3. The optical circuit chip according to claim 1, wherein the other end portion of the alignment waveguide is connected to a reflection circuit.

4. The optical circuit chip according to claim 2, comprising: two pairs of the alignment waveguides, wherein the fiber array is connected at a center between a relative position with respect to the fiber array determined in one pair of the alignment waveguides and a relative position with respect to the fiber array determined in the other pair of the alignment waveguides.

5. The optical circuit chip according to claim 2, wherein the fiber array has a plurality of optical fibers, and a spacing between a pair of the alignment waveguides is equal to a spacing between two arbitrary optical fibers among the plurality of optical fibers.

6. The optical circuit chip according to claim 1, wherein the first layer includes silicon.
